(19) United States
(12) Patent Application Publication
(10) Pub. No.: US 2010/0181328 A1
(43) Pub. Date: Jul. 22, 2010

(54) Protective sleeve

(76) Inventors: Matthew R. Cook, Hinsdale, IL (US); Thomas Z. Fu, Naperville, IL (US); Barry Silverstein, Northbrook, IL (US)

Correspondence Address: BRINKS HOFER GILSON & LIONE, P.O. BOX 10395, CHICAGO, IL, 60610, US

(21) Appl. No.: 12/320,030

(22) Filed: Jan. 16, 2009

(51) Int. Cl. B65D 8/12; B65D 25/20; B31B 1/88

(52) U.S. Cl. 220/674; 220/737; 493/58

(57) ABSTRACT

A container and a sleeve for a container are disclosed that employ unique air channels to divert heat from a hot beverage via hot air escaping upward and downward. The surface of the container and sleeve include raised images, depressed images, or a combination of both which are generally aligned in substantially vertical columns. The space between the columns defines the air channels. The air channels are substantially uninterrupted and facilitate the upward and downward escape of hot air. The images are applied, such as by embossing and/or debossing, which facilitates manufacturing material efficiency and therefore reduces material costs and environmental waste. A blank for a container or sleeve and a method of making a sleeve are also disclosed.

### BACKGROUND

Hot and cold beverages or foods (e.g., coffee, tea, soft drinks, soup, and the like) may present a handling problem to consumers when dispensed into containers such as drinking cups. For example, single-wall paper, and plastic drinking cups often do not provide sufficient thermal insulating properties when filled with hot or cold beverages. As a result, handling of such containers may be uncomfortable to the consumer.

### BRIEF SUMMARY

A container and a protective sleeve for encircling a container are disclosed. The container and the sleeve include a body having a first edge and a second edge and a surface between the edges. Uniquely designed raised and/or depressed images are applied to the surface in a pattern which may be ordered or random. The pattern of raised and/or depressed images generally creates substantially uninterrupted air channels from the first edge to the second edge.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a perspective view of a sleeve assembled with a cup.

FIG. 2A is a view of an unassembled sleeve.

FIG. 2B is a top view of an assembled sleeve.

FIG. 3 is a graph illustrating an exemplary image.

FIG. 4A is a view of an unassembled sleeve.

FIG. 4B is a top view of an assembled sleeve.

FIG. 5A is a view of an unassembled sleeve.

FIG. 5B is a top view of an assembled sleeve.

FIG. 6A is a view of an unassembled sleeve.

FIG. 6B is a top view of an assembled sleeve.

FIG. 7 is an exemplary view of unassembled sleeves.

FIG. 8 is an exemplary view of an unassembled sleeve.

FIG. 9 is an exemplary view of an unassembled sleeve.

FIG. 10 is an exemplary view of an unassembled sleeve.

FIG. 11 is an exemplary view of an unassembled sleeve.

FIG. 12 is an exemplary view of an unassembled sleeve.

FIG. 13 is an exemplary view of an unassembled sleeve.

FIG. 14 is an exemplary view of an unassembled sleeve.

FIG. 15 is an exemplary view of an unassembled sleeve.

FIG. 16 is an exemplary view of an unassembled sleeve.

FIG. 17 is an exemplary view of an unassembled sleeve.

FIG. 18 is a perspective view of an exemplary container.

FIG. 19 is a flow diagram of a method of making a protective sleeve.

### DETAILED DESCRIPTION

A container and a protective sleeve for use with a container are disclosed. The sleeve may be used with a container, such as a cup, including the container disclosed herein. When placed on a container, such as a cup, the sleeve may provide a thermal barrier between the container and a hand of a user. The width of the sleeve from top to bottom may approximate the width, for example, of at least two fingers of an adult human hand, and the shape may accommodate placing a thumb and at least three fingers on the sleeve.

The container may be used alone or with a sleeve, for example, but not limited to, the sleeve disclosed herein. The container may be, for example, a cup, a soup container, or another container for retaining liquids such as coffee, tea, soft drinks, soup, and the like. The container may be manufactured applying the same principles as disclosed herein for the sleeve, for example, by slight size and shape modifications to the sleeve blank and the addition of a container bottom and optional container lip.

The present disclosure relates to the application to a sleeve blank or container blank of uniquely designed raised and/or depressed images. The images may be applied to a surface of the blank in a pattern which may be ordered or random. For example, the images may be applied as columns of images. The columns may be arranged such that air gaps remain between them. The air gaps may provide air channels which may provide horizontal insulation. The channels may be continuous and substantially uninterrupted. The thermal properties of the sleeve or container may be enhanced by the presence of the disclosed channels, for example, by reducing the rate of heat transfer between a container and a hand gripping the container.

The images may be applied to a surface of the sleeve and/or container blank by a process of embossing, debossing or both (e.g., in-line or off-line rotary or platter die). The use of embossing, debossing, or both to apply substantially uninterrupted air channels to the container or sleeve may reduce the amount of sheet material used as compared to containers or sleeves that use other methods of creating air channels, such as corrugating. For example, embossing, debossing, or both may be used to create air channels on a single sheet of material thereby approximating the thermal barrier of a multiple sheet sleeve. Reducing the amount of sheet material used in manufacturing protective sleeves may cause waste reduction, which may be better for the environment. The present disclosure illustrates many different image arrangements and shapes, all of which are illustrative and non-limiting.

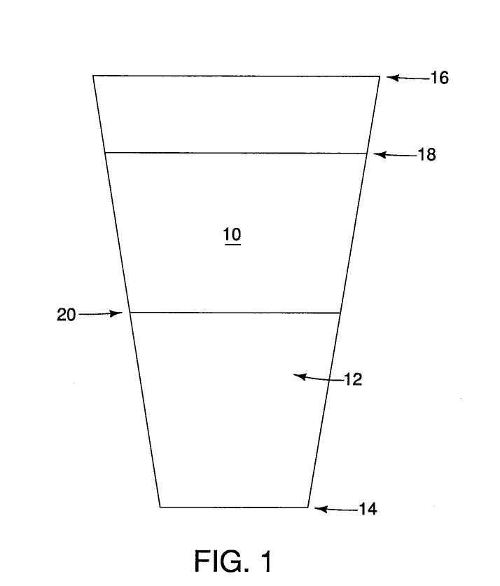

A protective sleeve 10 may be positioned in combination with a container 12 as in FIG. 1. The container 12 may be tapered and may have a base 14 and a rim 16. The container 12 may be manufactured of plastic, foam, paper, or any other material, and may be adapted to hold hot or cold food or beverages.

The sleeve 10 may be combined with the container 12 such that the sleeve 10 fully encircles the circumference of the container 12. The sleeve 10 may be attached to the container 12, such as by friction or by fugitive or non-fugitive glue. Alternatively, the sleeve may be integral with the container. The sleeve 10 may be manufactured of, for example, paperboard, cardboard, plastic, foam, cellulosic fiber, white virgin paper, brown recycled paper, or other materials and may be recyclable or compostable.

The sleeve 10 may include a first edge 18 and a second edge 20, which may be the top and bottom of the sleeve, or vice versa. The first edge 18 and the second edge 20 may be sized to fit a container 12, including a tapered or untapered container.

The protective sleeve 10 may be formed by fastening the ends of the elongate blank of the sleeve 10 together to form a continuous circle. The joined ends of the sleeve may be fastened by, for example, glue, a notch and slot arrangement, or other methods. The sleeve 10 may be affixed to the container by inserting the container into an assembled sleeve, or alternatively, wrapping the elongate blank of the sleeve 10 around the container.

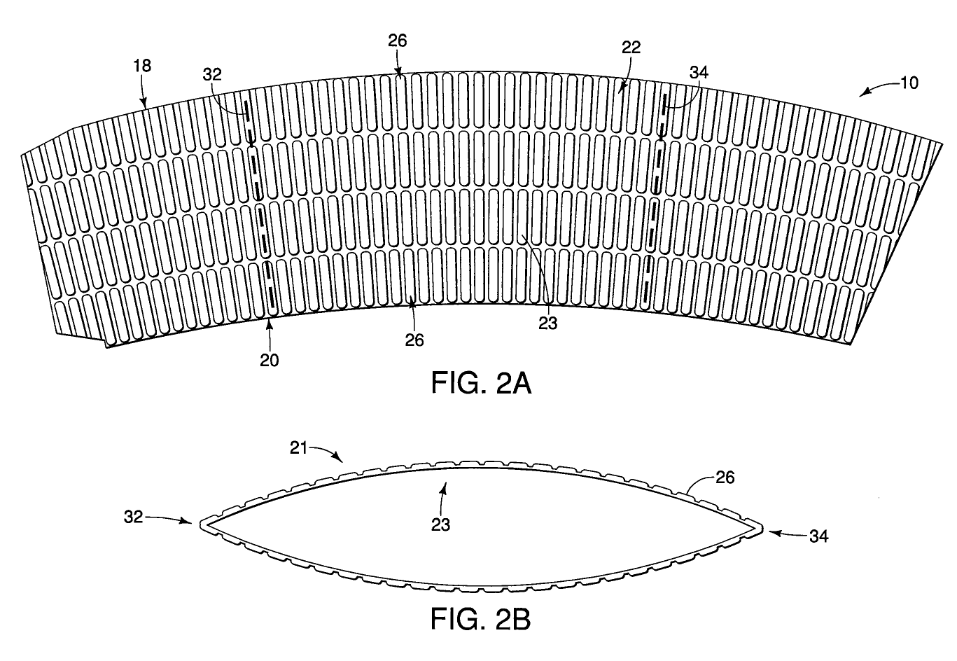

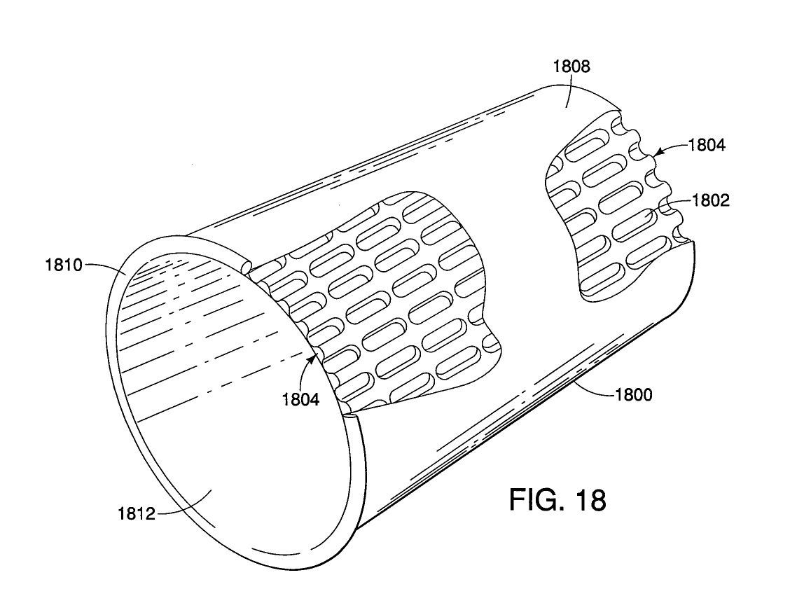

FIG. 2A illustrates an exemplary sleeve 10 in an unassembled state. The blank 10 in this and the following examples, FIGS. 2A, 4-17 (shown as a sleeve blank), may, with slight modifications (e.g., in size or shape), be useful as a blank for either a container, FIG. 18, 1800 or a sleeve FIG. 1, 10. The sleeve 10 may include a first edge 18 and a second edge 20, which may be the top and bottom of the sleeve 10, or vice versa. The sleeve 10 may further include a first surface 21 and a second surface 23 extended between the first edge 18 and the second edge 20. The first surface 21 and the second surface 23 may be the inside surface and the outside surface of the sleeve or container, or vice versa. For example, the first surface FIG. 2B, 21 may be the outside surface, which may contact the user's hand and the second surface 23 may be the inside surface which may contact the container FIG. 1, 12.

In this example, the sleeve 10 includes raised images 22. The images 22 of this example may be applied to the sleeve 10 by the process of embossing and/or debossing (e.g., rotary or in line die) and may be arranged in columns 26 that begin at the top 18 of the sleeve or container blank 10 and terminate at the bottom 20 of the sleeve or container blank 10. The images 22 may be positioned to form a pattern on the sleeve 10 as in this example, and/or the images 22 may be randomly placed on the sleeve 10 as in other examples disclosed herein. Additionally, the images 22 may be positioned such that the columns 26 follow the arc of the sleeve, or they may be positioned such that they are horizontal with the plane of the sheet material.

Each image 22 may have a shape. This example illustrates a generally rectangular image 22 with curved ends. However, the image 22 may be of any shape, for example but not limited to, square, polygon, triangle, circle, diamond, or any combination of these. The image 22 of this example may have a depth of, for example, 1 mm to 3 mm. However, other depths may be used.

The images 22 of this example may be applied to the sleeve 10 in columns 26, such as from the first edge 18 to the second edge 20 of the sleeve 10. The images 22 may be spaced one from another or may be continuous. If spaced one from another, the images 22 may have a gap from the closest gap feasibly possible based on manufacturing capabilities, to several millimeters, or, more specifically, approximately 2 mm to approximately 5 mm. The images 22 of the sleeve 10 may be arranged to define an air gap or air channel, for example, the images 22 may be arranged in columns 26 which are spaced to define air channels. The air channel between the columns 26 may be, for example but not limited to 1 mm to 5 mm. The air channel may be continuous or substantially uninterrupted such that air may flow freely through the channel (as opposed to being maintained in discrete pockets between the images 22).

The air channels may have vertical pitch of, specifically but not limited to, approximately Θ=0° to approximately Θ=60°, preferably to approximately Θ=45° with reference to the vertical axis from the top to the bottom of the sleeve 10. The air channels 24 may contribute to diversion of heat from the hot beverage via hot air escaping upward or downward away from a user's hands or fingers, and consequently, may contribute to the horizontal thermal insulation. The diversion of heat may increase the user's holding comfort. Additionally, the channels may add rigidity to the sleeve without using extra material.

FIG. 2B is a cross sectional view of an assembled sleeve or container blank 10. This view illustrates a cross sectional view air channels which may be created by the application of images FIG. 2A, 22, for example, in columns 26 of recessed or raised images FIG. 2A, 22. (With minor modifications, a cross section of a container FIG. 18, 1800 would appear similar.) The sleeve 10 blank may contain fold lines, 32 and 34, such that, when removed from a cup, the sleeve 10 can be collapsed into a flat plane. Collapsing into a flat plane may permit the sleeves to be efficiently packed in ready-to-use form. The flat-plane form of the sleeve 10 may also provide efficiencies for storing, for example, on counter tops, in storage containers, in boxes, on shelves, and etc.

The sleeve 10 may be converted from collapsed form to uncollapsed form by, for example, pushing inward on the fold lines 32 and 34. The uncollapsed form of the sleeve 10 may define an opening through which a container FIG. 1, 12 may be inserted.

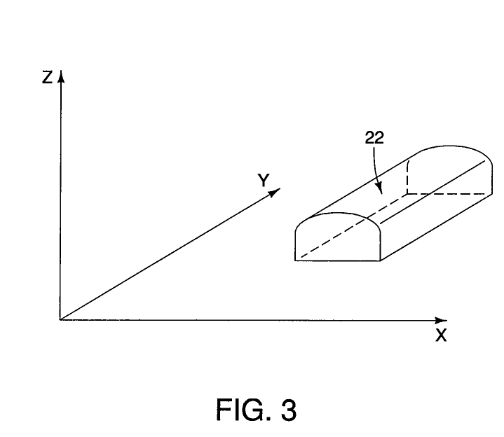

FIG. 3 illustrates a three dimensional rendering of an exemplary isolated image 22. In this example, the image 22 is a truncated semi-cylindrical shape. As illustrated, if viewed in an X-Y-Z plane, the image may have a generally polygonal planar shape, for example, if viewed in an x-y plane. Additionally, the thermal channels may have a curvilinear vertical or z-directional shape.

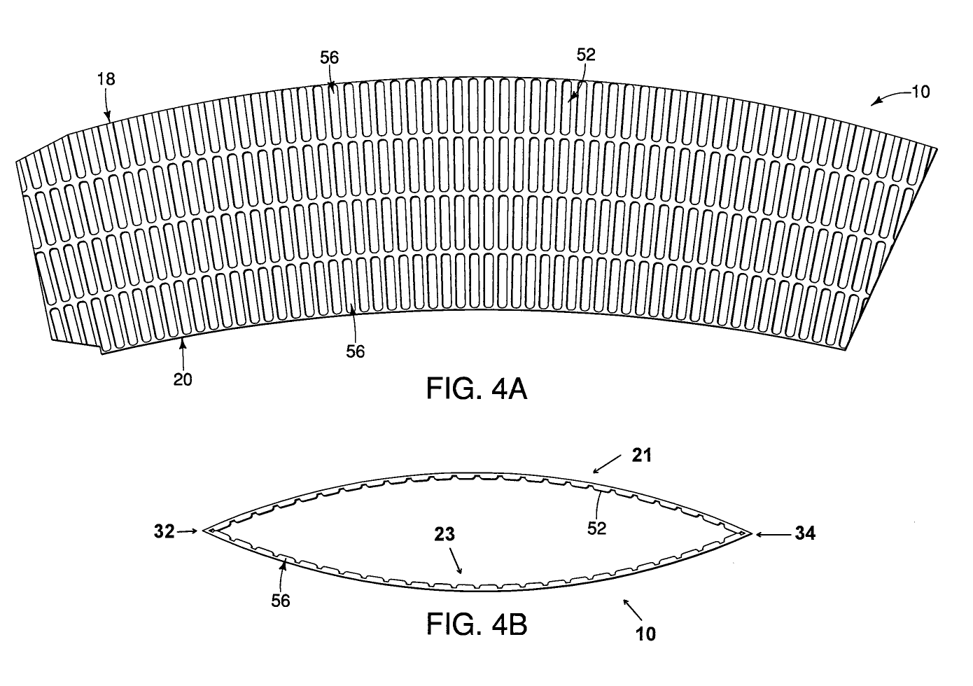

FIG. 4A illustrates a blank of an exemplary sleeve 10. The blank 10 may, with slight modifications (e.g., in size or shape), also be useful as a blank for a container, FIG. 18, 1800. In this example, the sleeve or container blank 10 has a pattern made up of individual images 52 which may be depressed images. The images 52 may be applied to the sleeve 10 by the process of embossing and/or debossing and may be arranged in columns 56 that begin at the top 18 of the sleeve 10 and terminate at the bottom 20 of the sleeve 10.

Each image 52 may have a shape. This example illustrates and generally rectangular image 52 with curved ends. However, the image 52 may be of any shape, for example but not limited to, square, polygon, triangle, circle, oval, diamond, or any combination of these. The image 52 of this example may have a depth of, for example, 1 mm to 3 mm. However, other depths may be used.

In this example, the sleeve includes depressed images 52. The images 52 of this example may be applied to the sleeve 10 by the process of embossing and/or debossing (e.g., in-line or off-line rotary or platter die) in columns 56 that begin at the top 18 of the sleeve 10 and terminate at or near the bottom 20 of the sleeve 10. The depressed images 52 may be positioned to form a pattern on the sleeve 10 as in this example, and/or the images 52 may be randomly placed on the sleeve 10. The images 52 may be spaced one from another or may be continuous. If spaced one from another, the images 52 may have a gap from the closest gap feasibly possible based on manufacturing capabilities to several millimeters, or more specifically to, for example but not limited, to approximately 1 mm to approximately 5 mm. The columns 56 of images 52 may also be spaced one from another. The gap between the columns 56 may be, for example but not limited to 1 mm to 5 mm.

The gap between the columns 56 may define or create air channels. The air channels may have a vertical pitch of approximately Θ=0° to approximately Θ=60°, preferably to approximately Θ=45° with reference to the vertical axis from top 18 to bottom 20 of the sleeve 10. The air channels may be continuous or substantially uninterrupted such that air may flow freely through the channel. The air channels may contribute to heat diversion from, for example, a hot beverage via air escaping upward and/or downward away from a user's hands or fingers. The diversion of heat may increase the horizontal thermal insulation of the sleeve; hence the user's holding comfort. Additionally, the channels may add rigidity to the sleeve or container without using extra material.

FIG. 4B is a cross sectional view of a sleeve FIG. 1, 10 (and with minor modifications may also approximate the appearance of a container FIG. 18, 1800 in cross section). This view illustrates the air channels which may be created by the application of images, for example, in columns 56 of depressed images FIG. 4A, 52 that may begin at or near the top 18 of the sleeve 10 and terminate at the bottom 20 of the sleeve 10.

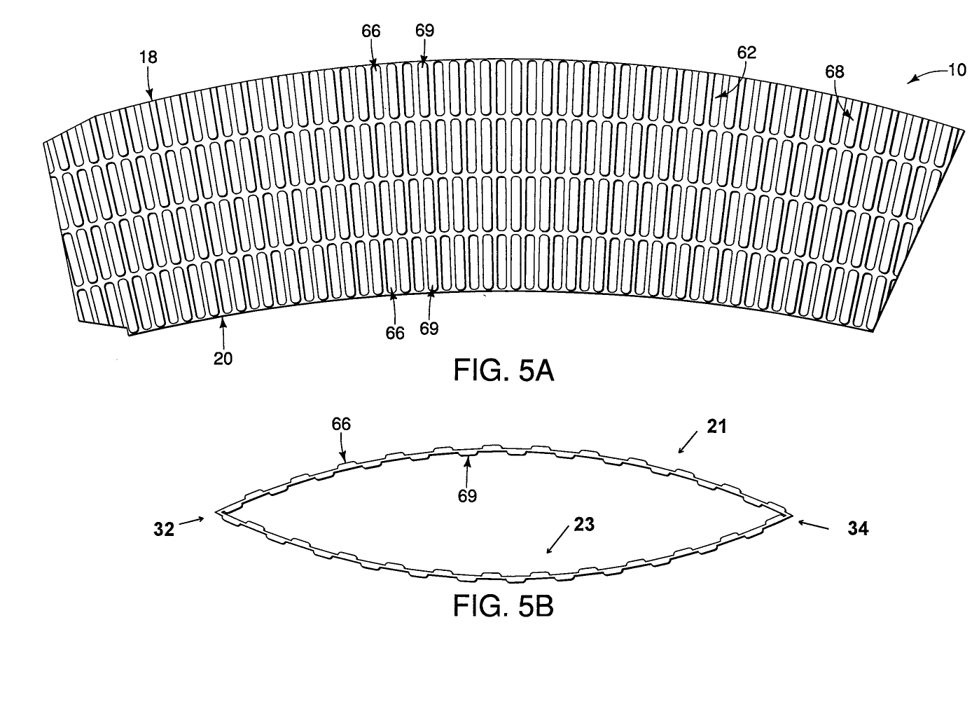

FIG. 5A illustrates a blank of an exemplary sleeve 10. The blank 10 in this example may, with slight modifications (e.g., in size or shape), be useful as a blank for a container, FIG. 18, 1800. In this example, the surface of the sleeve 10 includes a pattern made up of individual images 62, 68 some of which may be depressed images 62 and some of which may be raised images 68. The images 62, 68 of this example may be arranged in columns 66, 69 that begin at or near the top 18 of the sleeve 10 and terminate at or near the bottom 20 of the sleeve 10. The columns may consist uniformly of depressed images 62 as in 66, raised images 68 as in 69, or a combination of these.

Each image 62, 68 may have a shape. The shape of the images 62, 68 may be the same or may differ one from the other. This example illustrates a generally rectangular image 62, 68 with curved ends. However, the images 62, 68 may be of any shape, for example but not limited to, square, polygon, triangle, circle, oval, diamond, or any combination of these. The images 62, 68 of this example may have a depth of, for example, 1 mm to 3 mm. However, other depths may be used.

As discussed above, the images 62, 68 of this example may be applied to the sleeve 10 in columns 66, 69 that may begin at or near the top 18 of the sleeve and may terminate at or near the bottom 20 of the sleeve. The images 62, 68 may be spaced one from another or may be continuous within its respective column 66, 69. If spaced one from another, the images 62, 68 may have a gap from the closest gap feasibly possible based on manufacturing capabilities, to several millimeters, or more specifically to for example but not limited to approximately 1 mm to approximately 5 mm. The columns 66, 69 of images 62, 68 may also be spaced one from another. The gap between the columns 66, 69 may be, for example but not limited to approximately 1 mm to approximately 5 mm.

The sleeve may also contain air channels, which may be the result of the gaps between the columns 66, 69. The air channels may have a vertical pitch of, for example but not limited to, approximately Θ=0° to approximately Θ=60°, preferably to approximately Θ=45° with reference to the vertical axis from top 18 to bottom 20 of the sleeve 10. The air channels may be substantially uninterrupted and may contribute to heat diversion from, for example, a hot beverage via air escaping upward or downward away from a user's hands or fingers. The diversion of heat may contribute to horizontal thermal insulation and may increase the user's holding comfort. Additionally, the channels may add rigidity to the sleeve without using extra material.

FIG. 5B is a cross sectional view of a sleeve FIG. 1, 10. (With minor modifications, it demonstrates the appearance of the cross section of a container FIG. 18, 1800.) This view illustrates the air channels which may be created by the application of images 62, 68, for example, in depressed columns 66, or raised columns 69.

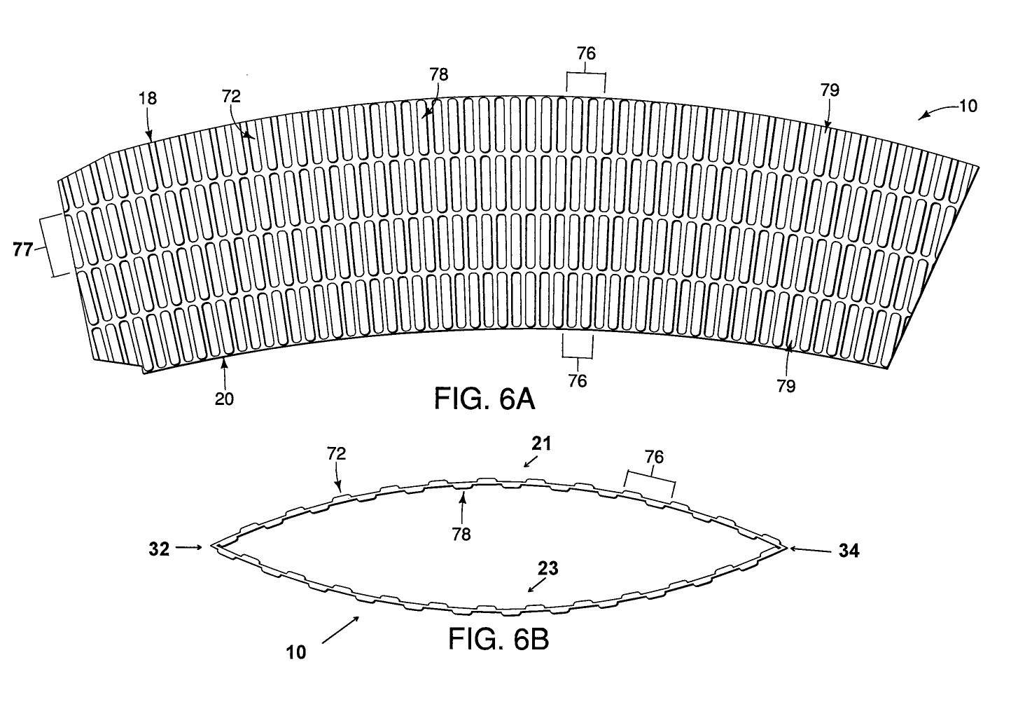

FIG. 6A illustrates a blank of an exemplary sleeve 10. The sleeve 10 blank in this example may, with slight modifications (e.g., in size or shape), be useful as a blank for a container, FIG. 18, 1800. In this example, the sleeve 10 has a pattern made up of individual images 72, 78 some of which may be depressed images 72 and some of which may be raised images 78. The images 72, 78 of this example may be arranged, for example, in mixed pairs 76 of depressed images 72 and raised images 78. Alternatively, the images 72, 78, may be arranged in pairs 76 of depressed images 72 only and raised images 78 only, or further, in triplets, quadruplets, or otherwise. Additionally or alternatively, the images 72, 78 may be arranged so that they alternate in repeating or random patters such as: depressed image 72, depressed image 72, raised image 78; raised image 78, raised image 78, depressed image 72; and others. The images 72, 78 may alternate (e.g., depressed image 72, raised image 78) across rows (as illustrated by the row marked by line 77) or the images 72, 78 may alternate (e.g., depressed image 72, raised image 78) down columns 79. For example, the images 72, 78 may alternate across both rows 77 and also alternate down columns 79. In another example, the images 72, 78 may alternate across rows 77 but not columns 79. Other examples of arrangements are also contemplated.

Each image 72, 78 may have a shape. The shape of the images 72, 78 may be the same or may differ one from the other. This example illustrates a generally rectangular image 72, 78 with curved ends. However, the images 72, 78 may be of any shape, for example but not limited to, square, polygon, triangle, circle, or any combination of these. The images 72, 78 of this example may have a depth of, for example, approximately 1 mm to approximately 3 mm. However, other depths may be used.

As discussed above, the images 72, 78 of this example may be applied to the sleeve 10 in pairs 76 or otherwise. The pairs 76 of images 72, 78 may be arranged in an offset arrangement as shown and may be spaced one from another or may be continuous within the pair 76. If spaced one from another, the images 72, 78 may have a gap from the closest gap feasibly possible based on manufacturing capabilities, to several millimeters, or for example but not limited to approximately 2 mm to approximately 5 mm. The pairs 76 may also be spaced one from another and, for example, off set. The gap between the pairs 76 in any direction may be, for example but not limited to approximately 1 mm to approximately 5 mm.

The images 72, 78 may be arranged to define and air channel. For example, the gaps between the columns 79 of the sleeve 10 may define air channels. The air channels may have a vertical pitch of, for example but not limited to, approximately Θ=60°. Preferably to approximately Θ=45° to approximately Θ=30° with reference to the vertical axis from top 18 to bottom 20 of the sleeve 10. The air channels may be substantially uninterrupted and may contribute to heat diversion from, for example, a hot beverage via hot air escaping upward or downward away from a user's hands or fingers. The diversion of heat may contribute to horizontal thermal insulation and may increase the user's holding comfort. Additionally, the channels may add rigidity to the sleeve without using extra material.

FIG. 6B is a cross-sectional view of a sleeve 10 and may also approximate the appearance of the cross section of a container FIG. 18, 1800. This view illustrates the air channels which may be created or defined by columns 79 of depressed images 72 alternating with raised images 78, which may be, for example, embossed and/or debossed.

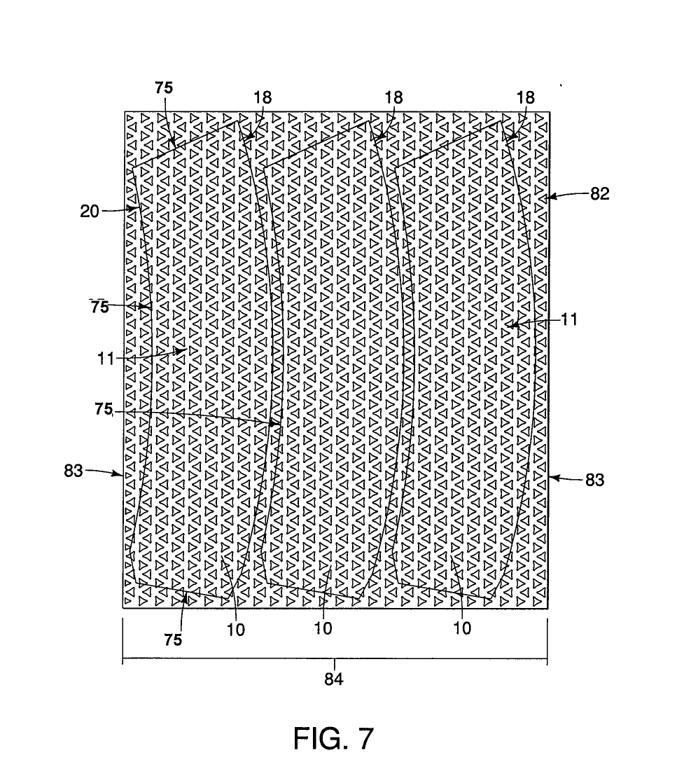

FIGS. 7-18 illustrate several contemplated variations image shapes, image application, and column arrangement.

FIG. 7 illustrates an arrangement of sleeve 10 blanks, for example, as cut lines 85 on sheet material 84. The sheet material 84 may contain one or more blanks of a sleeve 10, although not illustrated, the sheet material may also contain one or more blanks of a container FIG. 18, 1800. The blank 10 in this example may, with slight modifications (e.g., in size or shape), be useful as a blank for a container, FIG. 18, 1800. The sleeve 10 blanks may be positioned on the sheet material 84 in a repeating pattern.

As in this example, the images 82, which may be raised images or depressed images, may be applied to the entire sheet material 84. After applying the images 82 the sleeves may be isolated from the sheet material by releasing the sleeve 10 blanks along their cut lines 85. This example also illustrates how images 82 may be created in different shapes. In this example, the images 82 are shown as generally triangular. The images 82 of this example may be applied to the sleeve 10 blank by the process of embossing and/or debossing (e.g., in-line or off-line rotary or platen die) and may be arranged in columns 83 that begin at the top 18 of the sleeve 10 and terminate at or near the bottom 20 of the sleeve 10. The images 82 may be positioned to form a pattern on the sleeve 10 as in this example, or the images 82 may be randomly placed on the sleeve as in the other examples disclosed herein. Additionally, the images 82 may be arranged horizontal with the plane of the sheet material as shown or may follow the arc of the sleeve 10, as in the illustrations above (e.g., FIG. 2A).

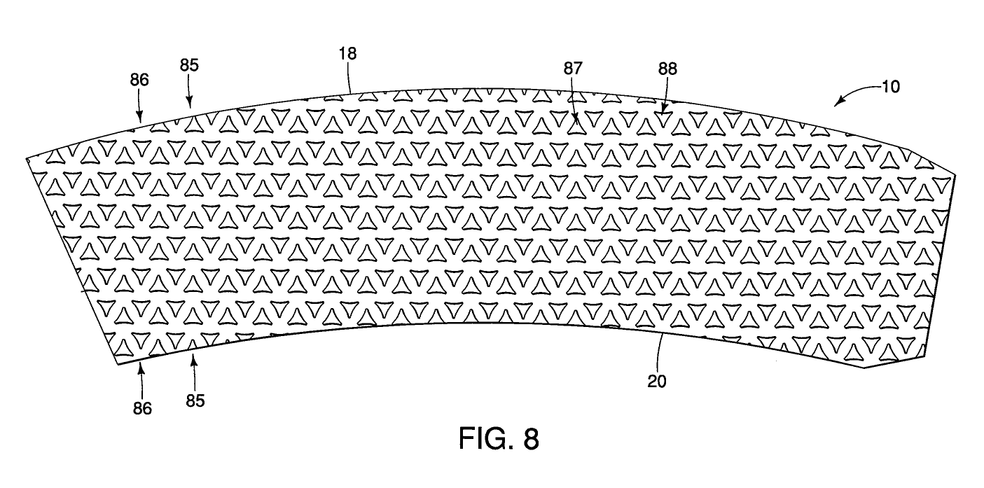

FIG. 8 illustrates a blank containing another exemplary sleeve 10 and illustrating the variation of possible shapes and designs of applied images 87, 88. In this example, the images 87, 88 are shown as generally triangular. The images 87, 88 of this example may be applied to the sleeve 10 as raised images 87 or as depressed images 88 by the process of embossing and/or debossing (e.g., in-line or off-line rotary or platen die) and may be arranged in columns 85, 86 that begin at the top 18 of the sleeve 10 and terminate at or near the bottom 20 of the sleeve 10. In this example, the images 87, 88 are arranged in alternating raised image columns 85 and depressed image columns 86. The images 87, 88 may be positioned to form a pattern on the sleeve or container blank 11 as in this example, or the images 87, 88 may be randomly placed on the sleeve as in the examples above. Alternatively, the patterns may be alternated in other ways, such as repeating patters of: embossed image column 85, raised image column 85, depressed image column 86; raised image column 86, depressed image column 86, raised image column 85; and others.

The gap between the columns 85, 86 may be air channels which may have a vertical pitch of, for example but not limited to, approximately Θ=0° to approximately Θ=60°, preferably to approximately Θ=45° with reference to the vertical axis from top 18 to bottom 20 of the sleeve 10. The air channels may facilitate heat via hot air flow up or down away from a users hand.

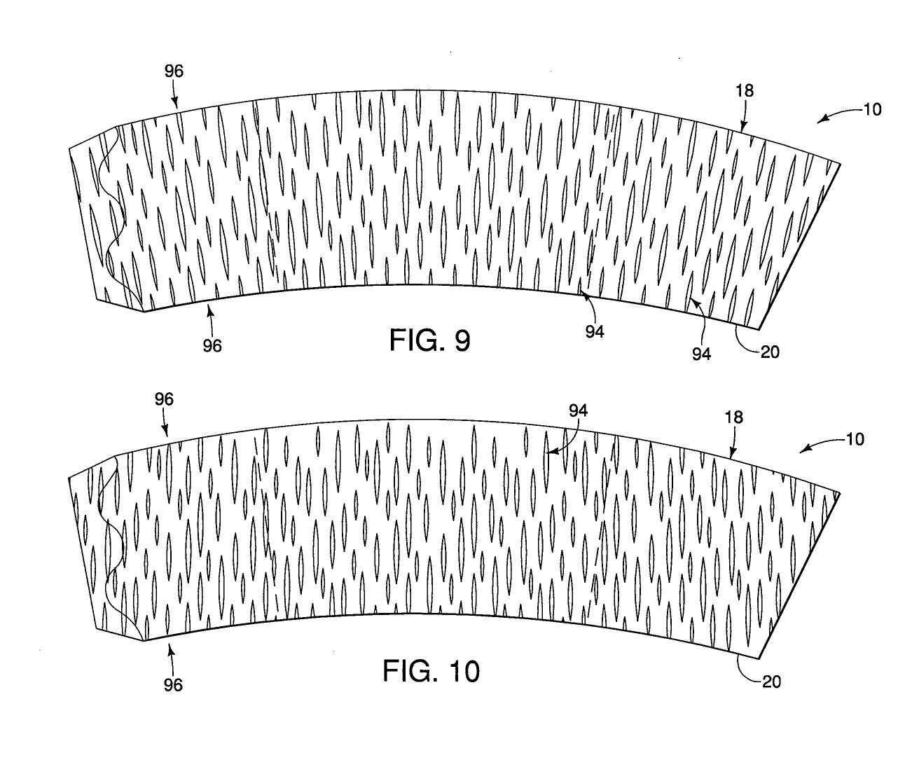

FIG. 9 illustrates a variation in the image shapes, image application, and column arrangement. In this example, the image 94 may be oblong and may be applied to the sleeve 10 in various sizes. Any number of sizes may be applied. As discussed above, the images 94 may be raised, depressed, or a combination of these and may be applied by, for example, embossing and/or debossing. The images 94 may be applied in columns from the top 18 of the sleeve 10 to the bottom 20 of the sleeve 10. The images 94 may be arranged on above each other within a column 96. Each column 96, may be made up of images 94 of the same size, or of various sizes. As discussed above, the images 94 within a column 96 may be continuous, or may be spaced one from another. The columns 96 may be spaced one from another, the spaces between the columns defining air channels. The columns 96 and/or air channels may be arranged such that they follow the arc of the sleeve, or alternatively, the columns 96 and/or air channels may be arranged horizontal to the plane of the sheet material as in FIG. 10.

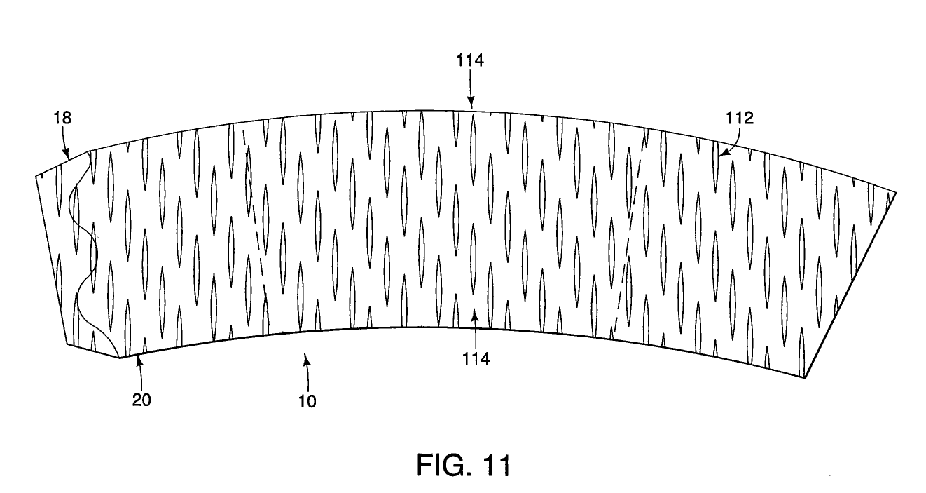

FIG. 11 illustrates an alternative pattern of images 112 which may be oblong and may be applied to the sleeve or container blank 11 in a uniform size. As discussed above, the images 112 may be raised, depressed, or a combination of these and may be applied by, for example, embossing and/or debossing. The images 112 may be applied in columns 114 from the top 18 of the sleeve 10 to the bottom 20 of the sleeve 10. The images 112 may be arranged one above each other within a column 114. Each column 114 may be made up of images 112 of the same size. Each column 114 may be spaced one from another, for example, approximately 1 mm to 5 mm apart and further, each column 114 may be offset from the neighboring column 114. The spaces between the columns may define air channels which may have a vertical pitch of for example but not limited to approximately Θ=60°, preferably to approximately Θ=45° to approximately Θ=30° with reference to the vertical axis from the top 18 to bottom 20 of the sleeve or container blank 10. As discussed above, the images 112 within a column 114 may be continuous, or may be spaced one from another. The columns 114 may be arranged horizontal to the plane of the sheet material as shown, or alternatively, the columns 114 may be arranged such that they follow the arc of the sleeve.

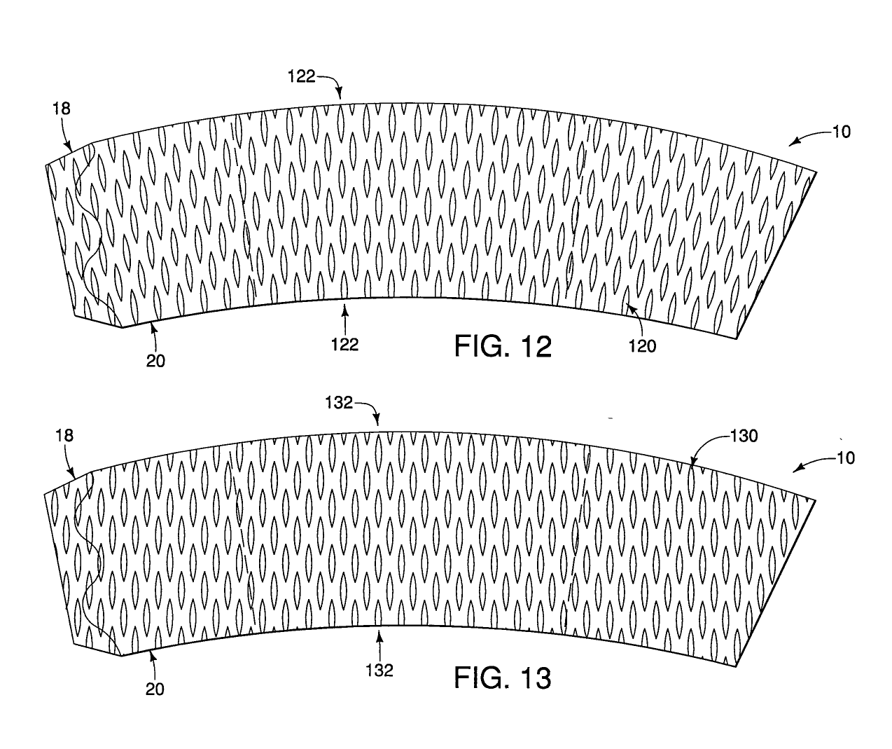

FIGS. 12 and 13 illustrate an alternative pattern of images 120, 130 which may be oblong and may be applied to the sleeve 10 in a uniform size as shown or in varying sizes. As discussed above, the images 120, 130 may be raised, depressed, or a combination of these and may be applied by, for example, embossing and/or debossing. The images 120, 130 may be applied in columns 122, 132 from the top 18 of the sleeve or container blank 11 to the bottom 20 of the sleeve or container blank. The images 120, 130 may be arranged on above each other within a column 122, 132. Each column 122, 132 may be spaced one from another, for example, approximately 1 mm to 5 mm apart and additionally, each column 122, 132 may be offset from the neighboring column. The spaces between the columns may define air channels which may have a vertical pitch of for example but not limited to approximately Θ=0° to approximately Θ=60°, preferably to approximately Θ=45° with reference to the vertical axis from top 18 to bottom 20 of the sleeve 10. As discussed above, the images 120, 130 within a column 124, 134 may be continuous, or may be spaced one from another. FIGS. 12 and 13 illustrate images 120, 130 which are placed closely together relative to the placement of the images in FIGS. 10 and 11. The columns 132 may be arranged horizontal to the plan of the sheet material as shown in FIG. 13, or alternatively, the columns 122, 132 may be arranged such that they follow the arc of the sleeve or container blank as shown in FIG. 12.

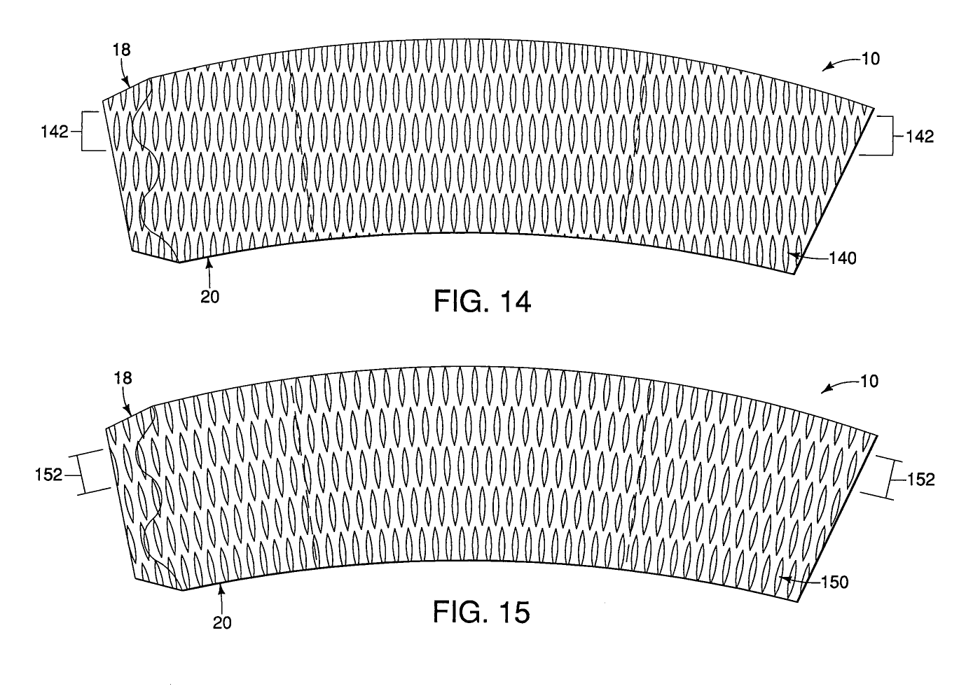

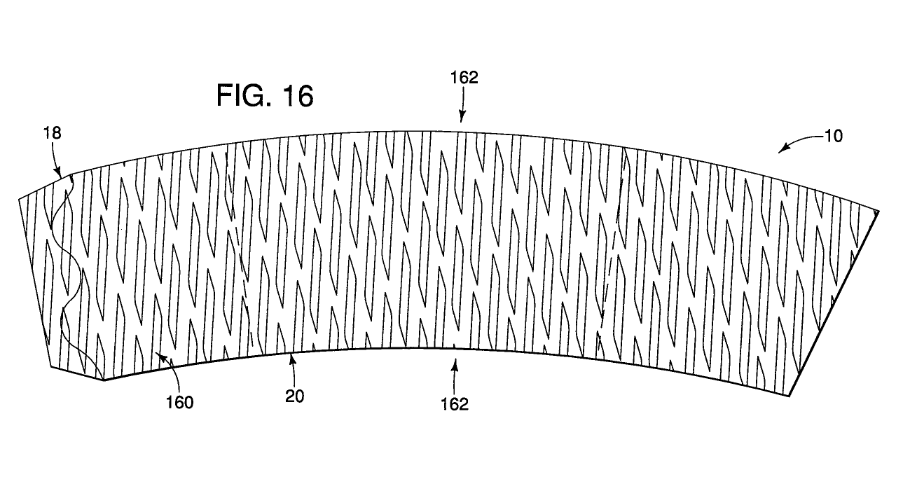

FIGS. 14 and 15 illustrate a surface on which the images 140, 150 are moved increasingly close together in rows 142, 152 while still maintaining air channels which may permit horizontal and near vertical heat flows. The images 140, 150 may be aligned horizontal with the plane of the sheet material as shown in FIG. 14, or may be aligned with the arc of the sleeve or container blank as in FIG. 15.

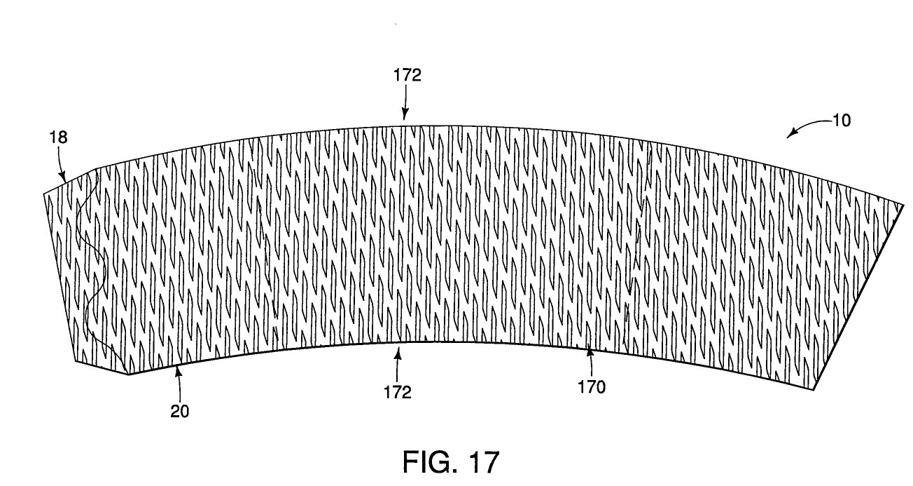

FIGS. 16 and 17 illustrate further variations of image shape, placement, and column arrangement which may facilitate multidirectional heat or hotair flow up or down away from a users hand. FIGS. 16 and 17 illustrate images 160, 170 which are generally trapezoidal. The images are aligned in columns which are offset from neighboring columns and create horizontal and other directional air channels as discussed above.

While the disclosure above primarily references the sleeve, a container embodiment is described in FIG. 18, which illustrates a cut away view of a container imprinted with images as described above. Any of the sleeve blanks illustrated in FIGS. 1-17 may be easily modified to form a container with the same features. The container 1800 may include a lip 1810, images 1802 arranged in columns 1804 defining air channels, a bottom, and an optional exterior liner or outer wrap 1808. The images 1802 imprinted on the container 1800 (for example, by embossing or debossing) may be of any of the patterns disclosed or described above. The air channels are substantially uninterrupted and facilitate horizontal insulation.

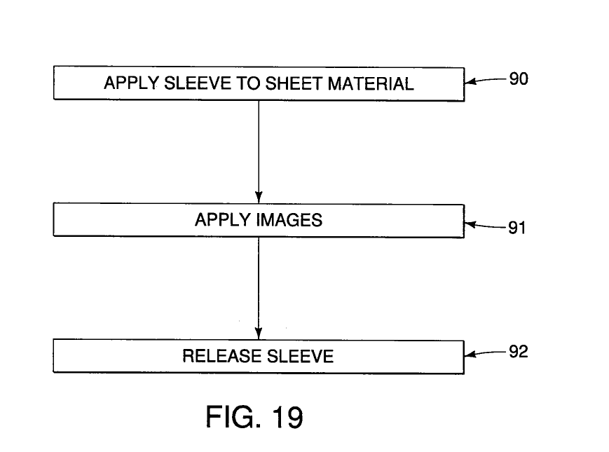

FIG. 19 shows an exemplary method for forming a sleeve FIG. 1, 10 or container FIG. 18, 1800. Box 90 may contain a step of applying images to a sheet material by embossing and/or debossing (e.g., in-line or off-line rotary or platen die), box 91 may contain a step of cutting a sleeve 10 or container blank FIG. 18, 1800 to a sheet material, for example, with cut lines; and box 92 may contain the step of releasing the sleeves from the sheet material at their cut lines. The sequence of the steps may be altered and additional steps may be added.

While various embodiments of the invention have been described, it will be apparent to those of ordinary skill in the art that many more embodiments and implementations are possible that are within the scope of the invention.

We claim:

1. A sleeve for encircling a container, comprising:
a body having a first edge and a second edge and a surface between the edges;
wherein the sleeve includes raised or depressed images over the surface;
wherein the images are arranged in columns that begin at the first edge of the sleeve and terminate at the second edge of the sleeve; and
wherein the gaps between the columns define substantially uninterrupted air channels from the first edge to the second edge.

2. The sleeve of claim 1, wherein the image further comprise a generally rectangular shape with curved ends.

3. The sleeve of claim 2, wherein the rectangular shape is a planar polygon in the X-Y plane and is curvilinear in the Z plane.

4. The sleeve of claim 1, wherein the image has a depth of several mm, preferably 1 mm to approximately 5 mm.

5. The sleeve of claim 1, wherein the images are spaced substantially vertically one from another creating columns.

6. The sleeve of claim 1, wherein the channels have a vertical pitch of approximately Θ=0° to approximately Θ==60°, preferably to approximately Θ=45° with reference to the vertical axis from top to bottom of the sleeve.

7. The sleeve of claim 1, wherein the columns of images are spaced from each with a gap of several mm, preferably approximately 1 mm to approximately 5 mm.

8. The sleeve of claim 1, wherein the images are arranged in pairs comprising a raised image and a depressed image.

9. The sleeve of claim 8, wherein the images are further arranged in an offset pattern defining substantially vertical air channels.

10. The sleeve of claim 1, wherein the surface comprises columns of raised images alternating with columns of depressed images.

11. The sleeve of claim 1, wherein the surface comprises columns of raised images.

12. The sleeve of claim 1, wherein the surface comprises columns of depressed images.

13. A method for forming a sleeve, comprising:
applying images to the surface of a sheet material wherein the images are arranged in columns that begin at the first edge of the sleeve and terminate at the second edge of the sleeve;
wherein the columns are spaced one from another creating gaps;
the gaps between the columns defining substantially uninterrupted air channels; and
applying cut lines defining a blank to the sheet material;
wherein the blank comprises an elongate body have a first edge and a second edge.

14. The method of claim 13 wherein the images are raised.

15. The method of claim 13 wherein the images are depressed.

16. The method of claim 13 wherein images are applied by embossing.

17. The method of claim 13 wherein the images are applied by debossing.

18. The method of claim 13 wherein the images are applied by a combination of embossing and debossing.

19. The method of claim 13 further comprising cutting the blanks from the sheet material.

20. The method of claim 13 further comprising joining the ends of the blank to form a sleeve.

21. A container including sides, a body, and an opening for receiving liquids, the body further comprising:
a first edge and a second edge and a surface between the edges;
wherein the container includes raised or depressed images over the surface;
the images are arranged in columns that begin at the first edge of the sleeve and terminate at the second edge of the sleeve; and
wherein the gaps between the columns define substantially uninterrupted air channels from the first edge to the second edge.

22. The container of claim 21, wherein the image further comprise a generally rectangular shape with curved ends.

23. The container of claim 22, wherein the rectangular shape is a planar polygon in the X-Y plane and is curvilinear in the Z plane.

24. The container of claim 21, wherein the image has a depth of several mm, preferably approximately 1 mm to approximately 5 mm.

25. The container of claim 21, wherein the images are spaced substantially vertically one from another creating columns.

26. The container of claim 21, wherein the channels have a vertical pitch of approximately Θ=0° to approximately Θ=60°, preferably to approximately Θ=45° with reference to the vertical axis from top to bottom of the sleeve.

27. The container of claim 21, wherein the columns of images are spaced from each with a gap of several mm, preferably approximately 1 mm to approximately 5 mm.

28. The container of claim 21, wherein the images are arranged in pairs comprising a raised image and a depressed image.

29. The container of claim 28, wherein the images are further arranged in an offset pattern defining vertical air channels.

30. The container of claim 1, wherein the surface comprises columns of raised images alternating with columns of depressed images.

31. The container of claim 21, wherein the surface comprises columns of raised images.

32. The container of claim 21, wherein the surface comprises columns of depressed images.

33. The container of claim 21 further including an outer wrap.
